(19) United States
(12) Patent Application Publication
(10) Pub. No.: US 2025/0364148 A1
(43) Pub. Date: Nov. 27, 2025

(54) Vacuum Transition for Laser Fusion System

(71) Applicants: Robert O Hunter, Jr., Aspen, CO (US); Richard B. Holmes, Shingle Springs, CA (US)

(72) Inventors: Robert O Hunter, Jr., Aspen, CO (US); Richard B. Holmes, Shingle Springs, CA (US)

(21) Appl. No.: 18/673,879

(22) Filed: May 24, 2024

(51) Int. Cl. G21B 1/17; G21B 1/03; G21B 1/23

(52) U.S. Cl. CPC G21B 1/17; G21B 1/23; G21B 1/03

(57) ABSTRACT

In an Inertial Confinement Fusion System, ideally the target should be positioned in a helium environment at pressures of about 10⁻³ to 10⁻⁴ atmospheres, whereas away from the target the pressure may be as high at 1 atmosphere. To account for this transition, various approaches may be considered. A laser window is not always feasible because the intense laser can cause window damage. However, an approach using a controlled transition from high pressure of about 1 atmosphere to a low pressure of about 10⁻³ atmosphere is a beneficial alternative. To implement this controlled transition, two shutters are used to aid in the rapid opening and closing of transition for when the laser passes through to the target, combined with an approach for rapid recovery by applying pressure on both sides of the transition. To minimize medium inhomogeneities when the laser is passing through the transition region, a rapid pressure reduction approach may be used.

### BACKGROUND

A laser fusion system requires a region of vacuum surrounding the target in order to avoid laser breakdown near the target. On the other hand, the lasers and the associated delivery systems are typically operated and maintained in an air or gas environment at a pressure near 1 atmosphere. Hence a transition is required between roughly atmospheric pressure and vacuum. This transition can be implemented by windows if the fluence of the laser pulse is sufficiently low. However, at higher laser fluence, fluences greater than 3 Joules per square cm for a 1-nsec laser pulse at a wavelength of 248 nm, a window will not survive laser irradiance. Another approach that has been considered is a solid disposable interface that is burned away by the main laser pulse or a precursor pulse, but this introduces contamination that absorbs, scatters, and refracts laser energy. Hence non-window, non-solid solutions are desirable. These solutions may include various shutters and gas-flow-control approaches. These solutions must maintain good uniformity of the optical path difference (OPD) at the vacuum interface to ensure good uniformity and quality of the spots on target, while ensuring the target is in a low-vacuum environment. In some implementations of a laser fusion system, a gaseous laser gain medium is located some distance from the target, and this region should remain undisturbed when the laser seed passes through and is amplified by this medium. This invention can allow extremely high laser fluences, up to 10⁴ J per square cm, at the interface between a vacuum and a gas at near atmospheric pressure.

### BRIEF DESCRIPTION OF THE DRAWINGS

FIG. 1 shows schematic details of a vacuum transition assembly with the laser shutter assembly closed.

FIG. 2 shows schematic details of a vacuum transition assembly with the laser shutter assembly open.

FIG. 3 shows schematic details of the container for the vacuum transition region.

### SUMMARY

In an Inertial Confinement Fusion System, ideally the target should be positioned in a helium environment at pressures of about 10⁻³ to 10⁻⁴ atmospheres, whereas away from the target the pressure may be as high at 1 atmosphere. To account for this transition, various approaches may be considered. A dual-flap shutter to separate the vacuum from the high-pressure region which opens and closes quickly to ensure a line of sight of the laser to the target during laser projection. A vacuum tank that surrounds the helium portion of the laser path. The helium portion of the laser path is at or near atmospheric pressure. The vacuum tank quickly removes the helium in the transition region just before the laser passes through, to reduce OPD variations. Additional flaps at the interface, between the laser path and the vacuum tank, may be implemented to release the gas in the helium portion of the laser path. Various pumps may then be used to alter the pressure throughout the system. Pumps to restore the pressure in the helium portion of the laser path after the laser beam has passed through the transition region, so that nearby SBS gain region remains relatively undisturbed. Pumps to reduce the pressure in the target chamber after the target has detonated and the interface has closed.

### Specification

The term “approximately”, “about”, “near”, “roughly” refer to a given value ranging plus/minus 20%. For example, the phrase of “approximately 1 atmosphere” is intended to encompass a range of 0.8 to 1.2 atmospheres.

The term “dual-flap shutter” is defined as comprising two shutters that open with hinges on the sides of the aperture, and which open in opposite directions. This may be distinguished from a “dual-slot shutter”, in which the shutter comprises two shutters that are confined in slots so as to translate linearly such that each shutter blocks about one-half of the aperture and which together fully blocks and seals the aperture upon command.

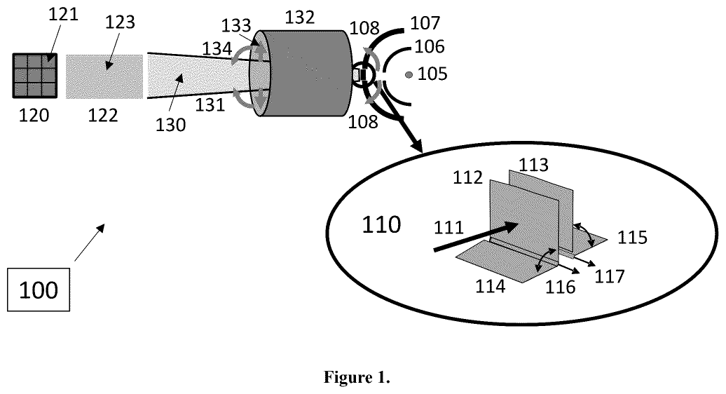

Vacuum Transition Assembly 100 (FIG. 1) includes the region 130 between the target containment vessel 107 and the nearest end of the laser gain region 123. In the laser gain region 123 there is a gaseous gain medium that is at or near atmospheric pressure. At the target containment vessel 107, the gas pressure is in the range of 10⁻³ to 10⁻⁴ atmospheres and is referred to as “low-vacuum,” and the preferred medium is helium to reduce the risk of laser-induced medium breakdown. Inside the containment vessel 107, which has a radius of approximately 5 meters, there is the target chamber 106 which has a radius of approximately 2 meters. Inside the target chamber 106 is the target 105 comprised of fusible material. The target is nominally at the center of the target chamber 106 when the laser arrives.

At the interface between the vacuum transition region 130 and the containment vessel 107 is a shutter assembly 110. The shutter assembly 110 is nominally at this location because it separates the low-vacuum region from the region at atmospheric pressure, and also because the laser 120 is small in transverse extent at this location as it focuses down to the target 105. The shutter could be moved closer to the target if needed, as close as the walls of the target chamber 106, in order to further reduce the needed shutter size. The shutter assembly 110 is subjected to greater debris, neutrons, and x-ray radiation when it is moved closer to the target 105, which will reduce the reliability and lifetime of the shutter assembly. If the shutter assembly is moved further from the target, it will need to be larger but there are no commercially available shutters that are available at this time. At the proposed location there are shutters of the required size and shutter speed that are commercially available, for example the Fast-Closing Shutter, Series 77.1/77.3, manufactured by the VAT Company with offices in San Jose, CA. The required shutter size is approximately 15 cm in diameter. The required shutter open/close time is approximately 10 msec each, based on the distance from the shutter to the gain region, about 20 meters, and the speed of sound in helium, about 1000 meters/sec at standard temperature and pressure.

The vacuum transition region 130 has the shape of a truncated cone, matching the dimensions of the laser as it focuses and propagates toward target 105. This helium-filled region is held in container 131 that also has the shape of a truncated cone. Surrounding this container is a vacuum tank 132 that will hold an efflux of helium 133 that is released from the vacuum-transition container 131 just before the laser propagates through the region. About 1 msec after the target detonation the efflux of helium in the vacuum tank is passed through pump 134 that puts it back into the container 131.

Some of the helium in the vacuum transition region 130 will also exit through the open laser shutter assembly 110 into the target containment vessel. This efflux will also be passed through pump 108 that pushes the gas through a filtering device (not shown) and back into the vacuum transition region. The filtering stage will remove non-helium residual gases and debris from the target detonation.

At the end of the vacuum transition region 130, the one that is furthest from the target 105, a section of gaseous medium 123 is present within region 122. In the preferred embodiment, this region 122 is a gain region that amplifies an incoming seed laser 120 as it propagates toward the target 105. Also in the preferred embodiment, the transverse area of the laser 120, the laser face, is sectioned into sub-apertures 121, to reduce medium inhomogeneity across any one sub-aperture so that the focal spots will be tightly focused and uniform. These sub-apertures may range in size from approximately 5 cm to 25 cm or more, based on estimates of the medium inhomogeneities and the required spot sizes on target.

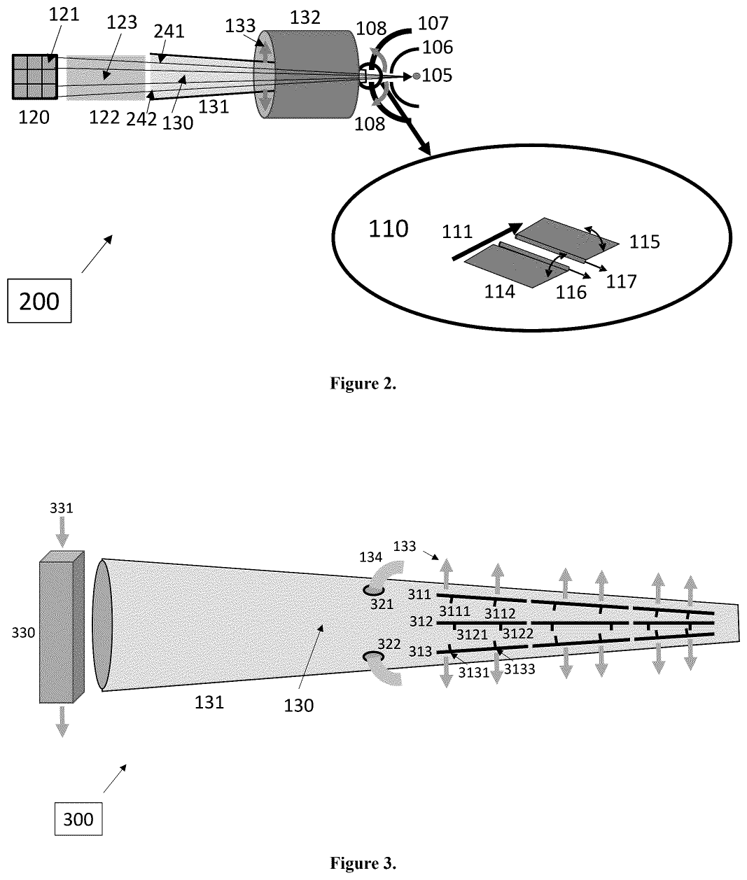

FIG. 1 shows the state of the laser shutter assembly, closed, when the laser is not propagating through the interface. FIG. 2 shows the state of the laser shutter, open, when the laser is propagating through the interface. FIG. 2 also shows the geometric envelopes 241 and 242 of the laser after passing through two sub-apertures and then propagating to the target.

FIG. 3 shows details of container 131 for the vacuum transition region 130. The container will have numerous rectangular openings that are sealed by slats such as 311, 312, and 313 when the laser is not propagating through the vacuum transition region 130. These slats are opened and closed by actuation components 3111 and 3112 for slat 311, for example. Similarly, slat 312 is opened and closed by actuation components 3121 and 3122, for example, and slat 313 is opened and closed by actuation components 3131 and 3132, for example. Note that when the vacuum transition region 130 is at or near atmospheric pressure and the vacuum tank is at low vacuum, the intrinsic pressure differential at the slats will increase the speed at which the slats open.

Also, at the end of the vacuum transition region 130, the one that is furthest from the target, there is a region 330 of flowing gas 331 that acts as an aero-window between the helium of the vacuum transition region 130 and the gas 123 in the gain region 122. This region/window 330 reduces the cross-contamination of the different gases on either side and ensures that the gain medium has a well-defined shape, i.e., a nominally flat surface, at the end nearest the vacuum transition region 130. The gain region 122 is always filled with a gaseous media, which has SBS gain in our embodiments. It should be noted that for most gain media, there is no gain at time where there is no pump laser (after accounting for the decay time of the gain process.

In operation, laser 111 enters the laser shutter assembly 110 from the left, the left laser flap shutter opens slowly (up to ˜1 sec) from position 112 to 114, before the pulse, with the right flap closed in position 113. Then the right laser flap shutter opens rapidly (<10 msec) from position 113 to 115, assisted by pressure and flow, just before the laser propagates through the shutter region. Both the shutters shown here are of the “flap” type, but “slot” type shutters are also available of comparable speed and size. The time requirement for the right flap shutter is set by the speed of sound in the transition gas and the distance between the right shutter. For example, the speed of sound V is about 1000 m/sec for helium as the transition gas and the distance D from the shutter to the nearest edge of the gain medium is about 20 meters. So, the right flap should open completely in a time substantially less than D/V=20 msec.

As the right flap 113 opens, a plurality of small round, square, or rectangular apertures along the laser conical cavity are opened rapidly (<5 msec) via valves comprising slats or flaps, shown as 311 to 313 in FIG. 3. This opening time should be substantially less than the opening time for the laser shutter, which is 10 msec in the example above, in order to ensure substantially complete evacuation of the gas of the transition region near the laser shutter. As mentioned earlier, these slats open rapidly, assisted by pressure and flow. These apertures are spaced at no more than 0.5-meter intervals along the conical cavity and may be situated at one or more azimuthal locations to speed the exit of the helium gas. Also, as the right flap 113 opens, one or more pumps 108 at the laser shutter location is brought up to maximum flow to pull the gas exiting into the target containment vessel 107 so that the bulk of the gas does not remain in the converter but is instead recycled into the vacuum transition region after the laser passes. When the right laser shutter is completely open, the laser interlock allows the laser to fire and about 4 microseconds later, the laser then propagates through the opening to the converter.

After the laser pulse propagates through the opening and after about 1 msec after the nominal target detonation time, laser shutter assembly 110 is in the state shown in FIG. 2. Then the left flap shutter closes quickly (<10 msec) to closed position 112 assisted by pressure and flow of the helium exiting the vacuum transition region. Then the right flap shutter closes slowly (up to ˜1 sec) to closed position 113. Then the slats 311 to 313 along the conical walls are closed in about 10 msec. The helium that exited the vacuum transition region is then recirculated back into the laser transition region over the course of up to a few seconds. This process is then repeated for the next lase pulse.

An Argon “plug” of gas may be employed near the laser shutter, to reduce the sound speed and efflux of the gas at the laser shutter. A magnetic field may be used to improve the speed of operation of the laser shutters if the shutters consist of a magnetic metal. Lateral flows may be used at the at walls to minimize boundary layers. A second shutter that is larger and slower may be used near the gain region to control transfer of the SBS gases to the helium region or vice versa (this shutter is in place only during times when it can be inserted and removed without interference of laser propagation). In addition, adaptive optics may be used to correct for aberrations that are repeatable from shot to shot in this application. Lenslet adjustment may be used to reduce OPD. Translating the lenslets can adjust for repeatable tip, tilt, and focus aberrations. Rotating the lenslets along transverse axes can reduce other higher-order aberrations such as coma.

The consideration of the optical path difference (OPD) of the medium is important. The evacuation of the vacuum transition to a helium density of a density of about 10⁻²× atmospheric density will reduce the Gladstone-Dale constant n−1 from about 3.59×10⁻⁵ at STP to about 3.59×10⁻⁷, where n is the refractive index of the gas. With such a small refractive index, even density variations as large as 1% of the ambient density will produce an OPD of about (n−1)Dz=3.6×10−8 meters, i.e., 36 nm, for a 10-meter path Dz. This small OPD is negligible compared to the optical wavelength of most lasers, and is also negligible to the wavelength of 248 nm of the KrF laser which is the preferred embodiment. To achieve a reduction of 10⁻² in atmospheric density will require a vacuum tank that is about 100× the volume of the vacuum transition region. Since the volume of the vacuum transition region that is within 10 meters of the laser shutter is about 1.05 m³ for a laser focus/diameter ratio of 32, the required radius of the 10-meter-long vacuum tank is about 1.8 meters. Somewhat larger vacuum tanks can be used if a helium density less than 10⁻³ atmospheres is needed.

Also, it should be obvious to one skilled in the art that if the width of the input focusing region (the lens aperture) is smaller, there will be less OPD over the smaller width. It is estimated that the lens focusing aperture at the input plane should be from approximately 25 cm down to approximately 5 cm in width. A tiled array of lenses, also known as a lenslet array, can be used to achieve these smaller apertures over laser beam which has a considerably larger cross-section.

Alternative gas choices such as Argon, which has a slower sound speed than helium, might also be considered, as discussed above. However, Argon has a much larger value of n−1 which would more than compensate for the smaller Dz that would result from a slower sound speed. This lower sound speed can be used to advantage before the laser pulse to forestall the growth of the disturbed region. Then the Argon can be sucked away before the laser pulse arrives so that its larger refractive index will have negligible impact. Hence the use of Argon near the laser shutter might be of value. It should be mentioned that adaptive optics might be used to compensate for repeatable OPD disturbances. Non-repeatable aberrations are difficult to sense in this system, partly due to the geometry and partly due to the fast fluid dynamics. Finally, any lenses in the system can also be used in principle to correct for tip, tilt, focus and other higher-order aberrations such as coma.

Other key specifications for the vacuum transition system include the required characteristics of the laser shutter. Specific specifications include shutter lifetime, reliability, and maintenance intervals. If the shutter fails to open just before the laser passes through, the shutter would likely be vaporized by the incident laser beam and no laser fusion would occur. Hence a built-in sensor with a response time of about 1 msec is specified to verify the open status of the shutter. There is also a time accuracy for when the shutter starts to open. This accuracy should be about 0.5 msec. These desirable specifications are summarized in Table 1.

TABLE 1
Summary requirements/desirable specifications for the shutter

| Parameter | Threshold | | Objective | | Comments |
|---|---|---|---|---|---|
| Shutter Open Time | 10 | msec | 5 | msec | Ensures a helium gas that has little OPD |
| | | | | | when laser is present |
| Time from Start of | 15 | msec | 5 | msec | Ensures gain medium is not disturbed |
| Opening of Shutter to | | | | | but helium is rarefied and relatively |
| Laser Presence | | | | | uniform |
| Time to Close Shutter | 10 | msec | 5 | msec | Avoids mixing of different gases in fast |
| after Laser Presence | | | | | compressor |
| Aperture Shape | square | | Square or | | Conforms to laser shape |
| | | | rectangular | | |
| Aperture Width | 16 | cm | 16 | cm | Could be as small as 5 cm if the shutter |
| | | | | | is at the inner chamber of the converter. |
| Maintenance Interval | 10⁵ | cycles | 10⁶ | cycles | Open/close cycles |
| Timing Accuracy | 1 | msec | 0.1 | msec | Ensures shutter is open when laser |
| | | | | | passes |
| Open Verification | Yes | | Yes | | Needed reliability = 1 failure per 10 |
| | | | | | million shots |
| Open Verification | 1 | msec | 0.1 | msec | Allows failure detection before laser |
| Response Time | | | | | trigger |
| Vacuum/Medium | 30 | sec | 2 | sec | Time to recover vacuum at target, time |
| Recovery Time | | | | | to recover gain medium and helium |
| | | | | | densities before next pulse |
| Required RMS OPD | <80 | nm | <13 | nm | To ensure high-quality spots at the |

| | |
|---|---|
| across a coherent | target, better than 1.2× diffraction |
| aperture | limited |

It should be noted that these requirements have some flexibility. For example, a somewhat smaller shutter aperture could be used if the shutter were placed a bit closer to the target as noted in the table. If the inner shell of the converter has a 2-meter radius and the shutter is placed at this radius, it would only need to have a width of about 75*2/30=5 cm, and the required open/close times are much more achievable. However, the shutter mechanism is closer to the fusion detonations in this case and this certainly would affect shutter lifetime.

The specifications displayed and described herein are examples only, and not intended to limit the general principles of the invention.

1. A vacuum transition system to project a uniform energy to a fusion target, comprising:
a laser assembly to project a laser beam towards a fusion target;
a gain region positioned to receive and amplify the incoming laser beam from the laser assembly;
a vacuum transition region positioned to receive the amplified laser beam;
a containment vessel to receive the fusion target;
a vacuum tank located around the vacuum transition region, wherein the vacuum tank receives an efflux of Helium gas from the vacuum transition region just before the laser beam propagates through the vacuum transition region;
a laser shutter assembly located between the vacuum transition region and the containment vessel to quickly control an opening and closing of the laser shutter assembly to allow the laser beam to pass through;
one or more pumps to restore the pressure in the vacuum transition region, after the laser beam passes through; and
a pump valve positioned adjacent to each of the one or more pumps, to control the flow of Helium gas to the vacuum transition region;
wherein the one or more pumps pushes the Helium gas into the vacuum transition region after the laser shutter assembly closes to refill the vacuum transition region.

2. The vacuum transition system of claim 1, wherein the laser shutter assembly is a dual-flap shutter.

3. The vacuum transition system of claim 1, wherein the laser shutter assembly is a dual-slot shutter.

4. The vacuum transition system of claim 1, further comprising slats in the vacuum transition region, wherein the slats can be controlled to open when the laser is propagating through.

5. The vacuum transition system of claim 1, further comprising: a lenslet array that covers the cross-sectional area of the laser assembly, wherein the lenslet array provides a uniform energy deposition to project toward the fusion target.

6. The vacuum transition system of claim 5, wherein the lenslet array is adjustable to correct for a plurality of aberrations.

7. The vacuum transition system of claim 6, wherein the vacuum transition region has a shape of a truncated cone, wherein a receiving end-face of the truncated cone shaped vacuum transition region has a larger diameter, and which matches the cross-sectional area of the lenslet array.

8. The vacuum transition system of claim 7, wherein the laser shutter assembly further comprises a magnetic metal material.

9. The vacuum transition system of claim 8, wherein the magnetic metal material of the laser shutter assembly is controlled via a magnetic field in order to improve the opening and closing speed of the laser shutter assembly.

10. The vacuum transition system of claim 9, further comprising a plug near the laser shutter assembly, wherein the plug is a heavier gas.

11. A method for projecting uniform energy through a vacuum transition region to a fusion target comprising:
projecting a laser beam from a laser assembly towards a fusion target;
receiving and amplifying the projected laser beam in a gain region;
receiving the amplified projected laser beam to propagate through a vacuum transition region;
placing a fusion target in a containment vessel;
projecting a laser beam through the gain region then through a vacuum transition region toward the fusion target;
placing a vacuum tank around the vacuum transition region, wherein the vacuum tank receives an efflux of Helium gas from the vacuum transition region just before the laser beam propagates through the vacuum transition region;
controlling an opening and closing of a laser shutter assembly located between the vacuum transition region and the containment vessel as the laser beam passes through;
controlling the amount of Helium gas that is pushed into the vacuum transition region with one or more pumps, after the laser shutter assembly closes; and
restoring the pressure in the vacuum transition region after the fusion target has detonated and the laser shutter assembly has closed.

12. The method of claim 11, wherein the laser shutter assembly is a dual-flap shutter.

13. The method of claim 11, wherein the laser shutter assembly is a dual-slot shutter.

14. The method of claim 11, further comprising controlling the opening and closing of slats in the vacuum transition region as the laser beam is propagating through.

15. The method of claim 11, further comprising: projecting the laser beam through a lenslet array that covers the cross-sectional area of the laser assembly to provide a uniform energy deposition.

16. The method of claim 15, further comprising: adjusting the lenslet array to correct for a plurality of aberrations.

17. The method of claim 16, receiving the projected laser beam from the lenslet array in a truncated cone-shaped vacuum transition region, wherein the receiving end-face of the truncated cone shaped vacuum transition has a larger diameter, and which matches the cross-sectional area as the energy exits from the lenslet array.

18. The method of claim 17, wherein the laser shutter assembly further comprises a magnetic metal material.

19. The method of claim 18, further comprising: controlling the magnetic metal material of the laser shutter assembly via a magnetic field in order to improve the opening and closing speed of the laser shutter assembly.

20. The method of claim 19, wherein a heavier gas plug is placed near the laser shutter assembly.
